(19) United States
(12) Patent Application Publication
(10) Pub. No.: US 2026/0171526 A1
(43) Pub. Date: Jun. 18, 2026

(54) WIRELESS BATTERY MANAGEMENT SYSTEM WITH A CONTINUOUS BATTERY CELL MONITORING FUNCTION AND AN OPERATING METHOD THEREFOR

(71) Applicants: HYUNDAI MOTOR COMPANY, Seoul (KR); KIA CORPORATION, Seoul (KR)

(72) Inventors: Jun Baek, Hwaseong-si (KR); Jonghu Yoon, Hwaseong-si (KR); SungWook An, Hwaseong-si (KR); Beomgyu Kim, Hwaseong-si (KR); Woocheol Shin, Hwaseong-si (KR)

(73) Assignees: HYUNDAI MOTOR COMPANY, Seoul (KR); KIA CORPORATION, Seoul (KR)

(21) Appl. No.: 19/242,719

(22) Filed: Jun. 18, 2025

(30) Foreign Application Priority Data
Dec. 17, 2024 (KR) 10-2024-0188519

(51) Int. Cl. H01M 10/48; B60L 58/18

(52) U.S. Cl. CPC H01M 10/482; B60L 58/18

(57) ABSTRACT

A wireless battery management system includes at least one cell monitoring unit (CMU) configured to monitor a status of at least one battery module including a plurality of battery cells, and a battery management unit (BMU) configured to manage the at least one CMU through wireless communication with the at least one CMU. The at least one CMU continuously monitors the status of the plurality of battery cells included in the battery module, and upon or based on detecting or determining an abnormal state in at least one battery cell, notifies the BMU of the abnormal state of the battery cell. Upon or based on receiving notification of the abnormal state of the battery cell from the CMU, the BMU transitions from a sleep mode to an active mode, and responds to the abnormal state of the battery cell.

### CROSS-REFERENCE TO RELATED APPLICATION

This present application claims the benefit of and priority to Korean Patent Application No. 10-2024-0188519, filed on Dec. 17, 2024, in the Korean Intellectual Property Office, the entire disclosure of which is incorporated herein by reference.

### FIELD

The present disclosure relates to a battery management system and an operating method therefor, and more specifically, to a wireless battery management system and an operating method therefor.

### BACKGROUND

Batteries used in environmentally friendly vehicles such as electric vehicles (EVs), hybrid electric vehicles (HEVs), and plug-in hybrid electric vehicles (PHEVs) are high-voltage batteries that generate high voltage by connecting numerous battery cells of the same specifications in series/parallel.

A battery management system (BMS) is a device that controls and manages charging and discharging of such high-voltage batteries composed of numerous battery cells, and a BMS is composed of at least one cell monitoring unit (CMU) that monitors the battery cells and a battery management unit (BMU) that manages the at least one CMU.

The BMU and the CMU of a battery management system operate normally in an active mode while the vehicle is driving. However, when the ignition (IG) is turned off, the BMU and the CMU transition to a sleep mode after a predetermined time (e.g., 2 hours) while the vehicle is parked, and then wake up periodically (e.g., at 10-minute intervals) for a very short time (e.g., 10 seconds) to monitor the battery cells. After an additional predetermined time (e.g., 58 hours) has elapsed since the ignition was turned off, the BMU and the CMU transition to a total sleep mode, and do not perform battery cell monitoring.

However, recently, fires caused by batteries in parked electric vehicles have occurred frequently. In existing technology, because the BMU and the CMU transition to the sleep mode while the vehicle is parked and wake up only intermittently at relatively long intervals (e.g., every 10 minutes) for very brief periods (e.g., 10 seconds) to perform battery cell monitoring, abnormalities such as battery cell overvoltage, undervoltage, over-temperature, or under-temperature may occur during a time when the BMU and the CMU are not awake, and in such case, by the time the BMU and the CMU wake up and respond, a fire may have already progressed rapidly, resulting in significant damage to property and people.

Moreover, if the BMU and the CMU are operated normally in the active mode while the vehicle is parked, the power consumption of an auxiliary battery of the vehicle (e.g., a 12V lead-acid battery) that operates the BMU while the vehicle is parked increases, causing the auxiliary battery to discharge easily.

### SUMMARY

The present disclosure is directed to providing a wireless battery management system with a function of continuously monitoring battery cells of a high-voltage battery while an electric vehicle is parked, without significantly consuming power of an auxiliary battery of the vehicle, and an operating method therefor.

The present disclosure is further directed to providing a wireless battery management system with a continuous battery cell monitoring function in which a CMU continuously monitors the battery cells while the electric vehicle is parked, and upon detecting or determining an abnormal state of a battery cell, notifies the BMU to respond to the abnormal state, and an operating method therefor.

Aspects of the present disclosure are not limited to those mentioned above, and other aspects and advantages not mentioned above should be understood from the following description, and become more apparent from embodiments described below. Moreover, aspects of the present disclosure may be realized by the means and combinations thereof indicated in the claims.

According to one aspect of the present disclosure, a wireless battery management system may include a continuous battery cell monitoring function. The wireless battery management system includes at least one cell monitoring unit (CMU) configured to monitor a status of at least one battery module including a plurality of battery cells, and a battery management unit (BMU) configured to manage the at least one CMU through wireless communication with the at least one CMU. The CMU continuously monitors the status of the plurality of battery cells included in the battery module, and upon or based on detecting or determining an abnormal state in at least one battery cell, notifies the BMU of the abnormal state. The BMU, upon or based on receiving notification of the abnormal state of the battery cell from the CMU, transitions from a sleep mode to an active mode, and responds to the abnormal state of the battery cell.

The BMU transitions from the active mode to the sleep mode when or based on that the ignition is turned off.

The BMU operates in the sleep mode using standby power of an external battery after the ignition is turned off.

The CMU operates in the active mode during a preset continuous monitoring time after the ignition is turned off.

A wireless battery management system according another aspect of the present disclosure includes at least one cell monitoring unit (CMU) configured to monitor a status of at least one battery module including a plurality of battery cells, and a battery management unit (BMU) configured to manage the at least one CMU. The CMU includes a battery cell monitoring unit configured to continuously monitor a status of the plurality of battery cells included in the battery module and generate battery cell status information, and a BMU wireless interface unit configured to communicate wirelessly with the BMU and transmit the battery cell status information to the BMU. The BMU includes a CMU wireless interface unit configured to communicate wirelessly with the CMU and receive the battery cell status information, a power supply unit configured to supply standby power of an external battery to the CMU wireless interface unit, and a control unit configured to manage the CMU based on the battery cell status information received through the CMU wireless interface unit. The battery cell monitoring unit of the CMU, upon or based on detecting or determining an abnormal state in at least one battery cell, notifies the BMU of the abnormal state through the BMU wireless interface unit of the CMU. The control unit of the BMU, upon or based on receiving notification of the abnormal state of the battery cell from the CMU through the CMU wireless interface unit of the BMU, transitions from a sleep mode to an active mode and responds to the abnormal state of the battery cell.

The CMU wireless interface unit of the BMU wakes up or activates the control unit of the BMU upon or based on receiving notification of the abnormal state of the battery cell from the BMU wireless interface unit of the CMU.

The control unit of the BMU, upon or based on being woken up or activated by the CMU wireless interface unit of the BMU, requests battery cell status information from the CMU through the CMU wireless interface unit of the BMU, and determines whether an abnormal state of the battery cell exists based on the battery cell status information received from the CMU.

The CMU wireless interface unit of the BMU is continuously operated by standby power of the external battery supplied from the power supply unit of the BMU after the ignition is turned off.

A method for operating a wireless battery management system according to another aspect of the present disclosure includes: by a cell monitoring unit (CMU), continuously monitoring a status of a plurality of battery cells included in a battery module; by the CMU, detecting or determining an abnormal state in at least one battery cell, by the CMU; by the CMU, notifying a battery management unit (BMU) of the abnormal state of the battery cell through wireless communication; and by the BMU and upon or based on receiving notification of the abnormal state of the battery cell from the CMU, transitioning from a sleep mode to an active mode and responding to the abnormal state of the battery cell.

Continuously monitoring the status of the plurality of battery cells includes operating the CMU in the active mode during a preset continuous monitoring time after an ignition is turned off.

Responding to the abnormal state includes: by a CMU wireless interface unit of the BMU, waking up or activating a control unit of the BMU; by the control unit of the BMU, requesting battery cell status information from the CMU through the CMU wireless interface unit of the BMU; by the control unit of the BMU, determining whether an abnormal state of the battery cell exists based on the battery cell status information received from the CMU; and by the control unit of the BMU, upon or based on an abnormal state of the battery cell being determined (e.g., by the control unit of the BMU), responding to the abnormal state of the battery cell.

The method further includes generating, by a battery cell monitoring unit of the CMU, battery cell status information.

The method further includes: storing, by a control unit of the BMU, the battery cell status information; and storing, by a CMU wireless interface unit of the BMU, the battery cell status information. The battery cell status information stored by the control unit of the BMU and the battery cell status information stored by the CMU wireless interface unit of the BMU may be duplicated.

According to one or more embodiments of the present disclosure, when the ignition is turned off, the BMU transitions from the active mode to the sleep mode, and the CMU performs continuous monitoring. This enables continuous monitoring of battery cells in a high-voltage battery while an electric vehicle is parked, without significantly consuming the power of an auxiliary battery of the vehicle.

Moreover, according to one or more embodiments of the present disclosure, the CMU continuously monitors the battery cells while the electric vehicle is parked, and upon detecting or determining an abnormal state of a battery cell, notifies the BMU so that the abnormal state of the battery cell can be immediately responded to. This enables fires caused by the battery to be addressed or extinguished before progressing significantly, thereby greatly reducing damage to property and people.

### BRIEF DESCRIPTION OF THE DRAWINGS

The foregoing and other aspects, features, and advantages of the present disclosure, as well as the following detailed description of embodiments, should be better understood when read in conjunction with the accompanying drawings. For the purpose of illustrating the present disclosure, there are shown in the drawings example embodiments, it being understood, however, that the present disclosure is not intended to be limited to the details shown because various modifications and structural changes may be made therein without departing from the spirit of the present disclosure and within the scope and range of equivalents of the claims. Like reference numbers and designations in the various drawings indicate like elements.

FIG. 1 illustrates an operating method for a BMU and a CMU according to existing technology in a normal situation.

FIG. 2 illustrates an operating method for the BMU and the CMU according to existing technology in a situation in which an abnormality has occurred.

FIG. 3 illustrates an operating method for a BMU and a CMU according to one embodiment of the present disclosure in a normal situation.

FIG. 4 illustrates an operating method for the BMU and the CMU according to one embodiment of the present disclosure in a situation in which an abnormality has occurred.

FIG. 5 is a block diagram illustrating a wireless battery management system with a continuous battery cell monitoring function according to one embodiment of the present disclosure.

FIG. 6 is a flowchart illustrating a method for operating a wireless battery management system with a continuous battery cell monitoring function according to one embodiment of the present disclosure.

### DETAILED DESCRIPTION

Embodiments disclosed in the present specification are described in greater detail with reference to the accompanying drawings, and throughout the accompanying drawings, the same reference numerals are used to designate the same or similar components and redundant descriptions thereof are omitted. As used herein, the terms “module” and “unit” used to refer to components are used interchangeably in consideration of convenience of explanation, and thus, the terms per se should not be considered as having different meanings or functions. In relation to describing the present disclosure, when the detailed description of the relevant known technology is determined to unnecessarily obscure the gist of the present disclosure, the detailed description has been omitted. Furthermore, it should be understood that the appended drawings are intended only to help understand embodiments disclosed in the present document and do not limit the technical principles and scope of the present disclosure. Rather, it should be understood that the appended drawings include all of the modifications, equivalents or substitutes described by the technical principles and belonging to the technical scope of the present disclosure.

Although the terms “first,” “second,” “third,” and the like may be used herein to describe various elements, components, regions, layers, and/or sections, these elements, components, regions, layers, and/or sections should not be limited by these terms. These terms are only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

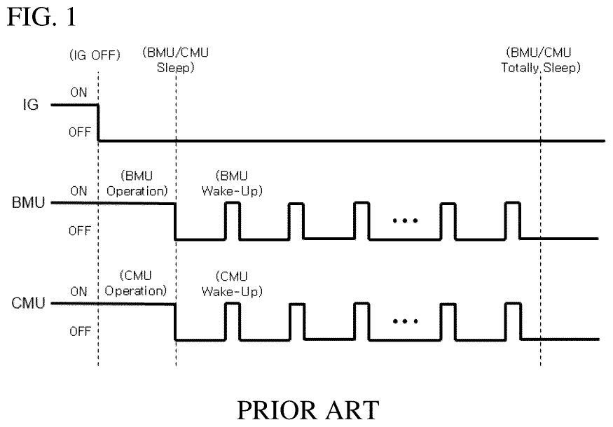

Hereinafter, a wireless battery management system with a continuous battery cell monitoring function according to an embodiment of the present disclosure, and an operating method therefor, are described in detail with reference to FIGS. 1-6.

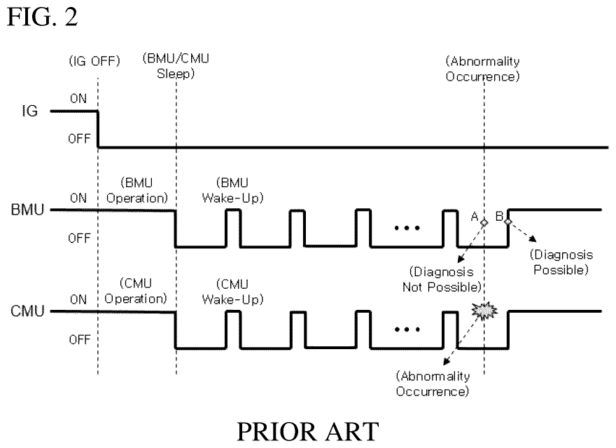

Before describing the present disclosure, an operating method for a battery management unit (BMU) and a cell monitoring unit (CMU) according to existing technology is described with reference to FIGS. 1 and 2.

FIG. 1 illustrates an operating method for a BMU and a CMU according to existing technology in a normal situation, and FIG. 2 illustrates an operating method for the BMU and the CMU according to existing technology in a situation in which an abnormality has occurred.

Referring to FIG. 1, in the existing technology, after an ignition (IG) is turned off, the BMU and the CMU operate normally in an active mode for a first predetermined time (e.g., 2 hours), and when a first predetermined time has elapsed after the ignition is turned off, the BMU and the CMU transition from the active mode to a sleep mode. The expression “turning on the ignition,” “IG ON” or the like may refer to powering on a vehicle (e.g., an EV) for driving, while the expression “turning off the ignition,” “IG OFF” or the like may refer to “driving power off,” of the vehicle. During a second predetermined time (e.g., 58 hours), the BMU and the CMU periodically wake up (e.g., at 10-minute intervals) for a very short time (e.g., 10 seconds) to perform battery cell monitoring. Once the second predetermined time elapses, the BMU and the CMU enter a total sleep mode, during which battery cell monitoring is not performed.

Referring to FIG. 2, in the existing technology, when the first predetermined time has elapsed after the ignition is turned off and the BMU and the CMU transition from the active mode to the sleep mode, the BMU and the CMU intermittently wake up for a very short time at relatively long intervals during a second predetermined time to perform battery cell monitoring. If a battery cell abnormality such as overvoltage, undervoltage, over-temperature, or under-temperature occurs while the BMU and the CMU are in the sleep mode (see time A in FIG. 2), battery cell diagnosis cannot be performed until the BMU and the CMU wake up again (see time B in FIG. 2). As a result, fire progresses rapidly until the BMU and the CMU wake up and respond, causing significant damage to property and people.

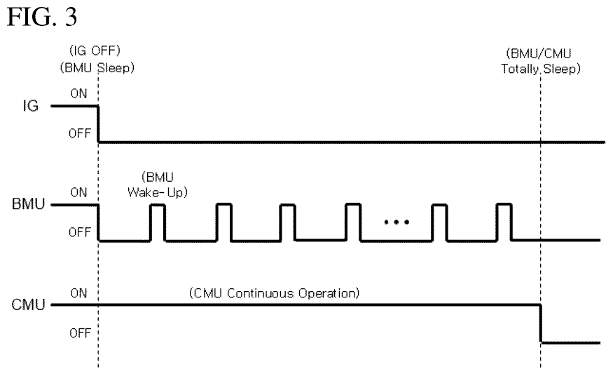

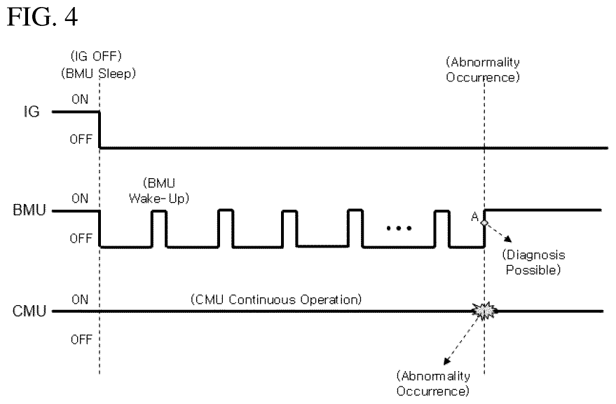

Hereinafter, an operating method for a BMU and a CMU according to one embodiment of the present disclosure in a normal situation is described with reference to FIGS. 3 and 4.

FIG. 3 illustrates an operating method for a BMU and a CMU according to one embodiment of the present disclosure in a normal situation, and FIG. 4 illustrates an operating method for the BMU and the CMU according to one embodiment of the present disclosure in a situation in which an abnormality has occurred.

Referring to FIG. 3, in one embodiment of the present disclosure, after an ignition (IG) is turned off, the BMU transitions from the active mode to the sleep mode, and periodically wakes up (e.g., at 10-minute intervals) for a very short time (e.g., 10 seconds) during a predetermined time (e.g., 60 hours) to intermittently manage the CMU. By contrast, after the ignition is turned off, the CMU maintains the active mode during the predetermined time (continuous monitoring time) to perform continuous monitoring of the battery cells. Once the predetermined time elapses, both the BMU and the CMU transition to the total sleep mode and do not perform battery cell monitoring.

Referring to FIG. 4, in one embodiment of the present disclosure, the CMU maintains the active mode during the continuous monitoring time after the ignition is turned off and performs continuous monitoring of the battery cells. If a battery cell abnormality such as overvoltage, undervoltage, over-temperature, or under-temperature occurs at any time (see time A in FIG. 4), the CMU in the active mode immediately detects or determines the abnormal state of the battery cell. Then, the CMU notifies the BMU of the abnormal state of the battery cell, and the BMU transitions from the sleep mode to the active mode to respond to the abnormal state of the battery cell.

Hereinafter, a wireless battery management system with a continuous battery cell monitoring function and an operating method therefor, for implementing the operating method for the BMU and the CMU according to an embodiment of the present disclosure as described above, are described according to one embodiment of the present disclosure.

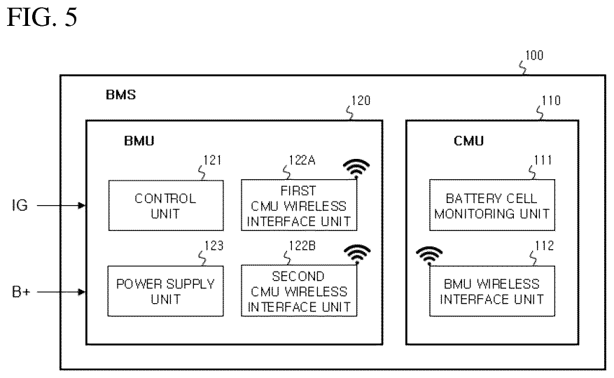

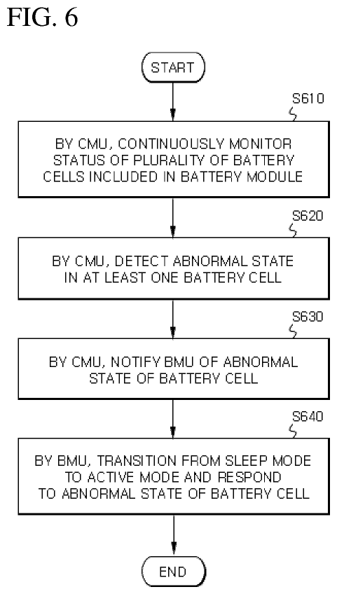

FIG. 5 is a block diagram illustrating a wireless battery management system with a continuous battery cell monitoring function according to one embodiment of the present disclosure. FIG. 6 is a flowchart illustrating a method for operating a wireless battery management system with a continuous battery cell monitoring function according to one embodiment of the present disclosure.

Referring to FIG. 5, a wireless battery management system (100) with a continuous battery cell monitoring function according to one embodiment of the present disclosure includes at least one cell monitoring unit (CMU, 110) configured to monitor a status of at least one battery module, and a battery management unit (BMU, 120) configured to manage the at least one CMU (110).

The CMU (110) constantly monitors the status (e.g., voltage, current, temperature) of a plurality of battery cells included in the battery module, generates battery cell status information, and transmits the battery cell status information to the BMU (120).

To this end, the CMU (110) according to one embodiment of the present disclosure includes a battery cell monitoring unit (111) and a BMU wireless interface unit (112), and the like.

The battery cell monitoring unit (111) performs continuous battery cell monitoring by maintaining an active mode during a preset continuous monitoring time (the predetermined time, or continuous monitoring time, discussed above with reference to FIG. 3) even after the ignition is turned off and the vehicle is parked (S610 in FIG. 6), and transmits battery cell status information to the BMU (120) through the BMU wireless interface unit (112). When the battery cell monitoring unit (111) detects or determines an abnormal state in at least one battery cell during the continuous monitoring (see S620 in FIG. 6), it notifies the BMU (120) of the abnormal state of the battery cell through the BMU wireless interface unit (112) (see S630 in FIG. 6). The battery cell monitoring unit (111) may be implemented as a battery monitoring integrated circuit (BMIC) or the like.

The BMU wireless interface unit (112) communicates wirelessly with the BMU (120) (specifically, a CMU wireless interface unit of the BMU) to transmit the battery cell status information generated by the battery cell monitoring unit (111) to the BMU (120), and receives control information, and the like from the BMU (120) and transmits the information to the battery cell monitoring unit (111). When the BMU wireless interface unit (112) receives notification of an abnormal state of a battery cell from the battery cell monitoring unit (111), the BMU wireless interface unit (112) transmits the notification to the BMU (120). The BMU wireless interface unit (112) may be implemented as a wireless integrated circuit (IC) or the like.

The BMU (120) receives the battery cell status information from the CMU (110) and determines a status of the battery cells, and based thereon, performs operations such as charging, discharging, and balancing. If the BMU (120) receives notification of an abnormal state of a battery cell from the CMU (110), the BMU (120) performs action (control) to address the abnormal state.

To this end, the BMU (120) according to one embodiment of the present disclosure includes a control unit (121), a CMU wireless interface unit (122), and a power supply unit (123), and the like. As used herein, a CMU wireless interface unit (122) may generally be referencing any one of a first CMU wireless interface unit (122A) or a second CMU wireless interface unit (122B).

The control unit (121) manages and controls the CMU (110) based on the battery cell status information received from the CMU (110). If the control unit (121) receives notification of an abnormal state of the battery cell from the CMU (110) while in the sleep mode after the ignition is turned off, the BMU (120) transitions to the active mode, determines whether a battery cell abnormality exists, and performs action (control) to respond to the abnormal state of the battery cell (see S640 in FIG. 6). The control unit (121) may be implemented as a microcontroller unit (MCU), a central processing unit (CPU), or the like.

The CMU wireless interface unit (122) communicates wirelessly with the CMU (110) (specifically, the BMU wireless interface unit (112) of the CMU), transmits the battery cell status information transmitted from the CMU (110) to the control unit (121), and receives control information, and the like from the control unit (121) and transmits the information to the CMU (110). When the CMU wireless interface unit (122) receives notification of an abnormal state of a battery cell from the CMU (110), it wakes up the control unit (121) and notifies the control unit (121) of the abnormal state of the battery cell.

In such case, according to an embodiment of the present disclosure, the CMU wireless interface unit (122) is implemented in duplicate as a first CMU wireless interface unit (122A) and a second CMU wireless interface unit (122B), so that when an abnormality occurs in any one of the first or the second CMU wireless interface unit (122A, 122B), the remaining one replaces it and operates normally, thereby preventing transmission failure in wireless communication and improving communication reliability. The CMU wireless interface unit (122) may be implemented as an interface integrated circuit (IC) or the like.

The power supply unit (123) supplies standby power (e.g., B+ power) from a vehicle's auxiliary battery (from the BMU's perspective, an external battery) to the control unit (121) and the CMU wireless interface unit (122). Even when the ignition is off and the control unit (121) is in the sleep mode (a non-operating state), the power supply unit (123) continuously supplies power to the CMU wireless interface unit (122), thereby maintaining the CMU wireless interface unit (122) in an on state so that communication between the CMU wireless interface unit (122) and the BMU wireless interface unit (112) is always possible. The power supply unit (123) may be implemented as a power management integrated circuit (PMIC) or the like.

Hereinafter, an operating method for a BMU and a CMU according to one embodiment of the present disclosure is described with reference to FIGS. 3-6.

After the ignition (IG) is turned off, the control unit (121) of the BMU (120) sets the power supply unit (123), which is connected to the standby power (e.g., B+ power) of an external battery (e.g., 12 V lead-acid battery), to continuously operate, so that the standby power of the external battery can be continuously supplied to the CMU wireless interface unit (122). In addition, the control unit (121) of the BMU (120) sets the CMU wireless interface unit (122) to operate continuously, thereby enabling constant communication with the BMU wireless interface unit (112) of the CMU (110).

The control unit (121) of the BMU (120) transitions from the active mode to the sleep mode to minimize power consumption.

The power supply unit (123) uses a real-time clock (RTC) or the like to periodically (e.g., every 10 minutes) wake up the control unit (121) for a very short time (e.g., 10 seconds) during a preset continuous monitoring time (e.g., 60 hours). Then, while woken up, the control unit (121) communicates with the CMU (110) through the CMU wireless interface unit (122) to perform battery cell monitoring.

The CMU (110) maintains the active mode during the continuous monitoring time even after the ignition (IG) is turned off, and continuously monitors the status of the battery cells (see S610 in FIG. 6).

In a normal situation, once the continuous monitoring time elapses, the CMU (110) and the BMU (120) transition to a total sleep mode and do not perform battery cell monitoring.

However, if a battery cell abnormality such as overvoltage, undervoltage, over-temperature, or under-temperature occurs (e.g., overvoltage, undervoltage, over-temperature, under-temperature is detected a predetermined number of times or more) at any time during the continuous monitoring of the CMU (110) (e.g., see time A in FIG. 4), the battery cell monitoring unit (111) of the CMU (110) in the active mode immediately detects or determines the abnormal state of the battery cell (see S620 in FIG. 6), and notifies the BMU (120) of the abnormal state of the battery cell through the BMU wireless interface unit (112) (see S630 in FIG. 6).

When the CMU wireless interface unit (122) of the BMU (120) receives a notification of the abnormal state of the battery cell from the BMU wireless interface unit (112) of the CMU (110), it wakes up the control unit (121) of the BMU (120).

Then, the control unit (121) of the BMU (120) transitions from the sleep mode to the active mode, identifies the cause of the wake-up, and if it determines that the wake-up was caused by the CMU wireless interface unit (122), requests battery cell status information from the CMU (110) through the CMU wireless interface unit (122) of the BMU (120), and determines whether an abnormal state of a battery cell exists based on the battery cell status information received from the CMU (110).

If an abnormal state of the battery cell is determined, the control unit (121) of the BMU (120) and the CMU wireless interface unit (122) of the BMU (120) each store the battery cell status information so as to store the battery cell status information in duplicate, and the control unit (121) of the BMU (120) performs action (control) to respond to the abnormal state of the battery cell (see S640 in FIG. 6).

As described above, according to an embodiment of the present disclosure, when the ignition is turned off, the BMU transitions from the active mode to the sleep mode, and the CMU performs continuous monitoring. This enables continuous monitoring of battery cells in a high-voltage battery while an electric vehicle is parked, without significantly consuming the power of an auxiliary battery of the vehicle.

For example, in existing technology, after the ignition is turned off, the BMU and the CMU operate normally in the active mode for 2 hours, and then wake up every 10 minutes for 10 seconds over the next 58 hours to perform battery cell monitoring, consuming approximately 13 mA of power. Further, if the BMU and the CMU operate continuously in the active mode for 60 hours after the ignition is turned off, approximately 200 mA of power is consumed.

However, according to an embodiment of the present disclosure, after the ignition is turned off, the BMU transitions from the active mode to the sleep mode, and only the CMU wireless interface unit continuously operates using the standby power of the external battery (e.g., B+ power). As a result, only about 8.1 mA of power is consumed over 60 hours after the ignition is turned off, thereby preventing the external battery from discharging while also enabling continuous monitoring of the battery cells.

As used in the present disclosure (especially in the appended claims), the terms “a/an” and “the” include both singular and plural referents, unless the context clearly states otherwise. Also, it should be understood that any numerical range recited in the present disclosure is intended to include all sub-ranges subsumed therein (unless expressly indicated otherwise) and accordingly, the disclosed numeral ranges include every individual value between the minimum and maximum values of the numeral ranges.

The steps constituting the method according to an embodiment of the present disclosure may be performed in an appropriate order unless a specific order is described or otherwise specified. In other words, the present disclosure is not necessarily limited to the order in which the steps are recited. All examples described in the present disclosure or the terms indicative thereof (“for example”, “such as”) are merely to describe the present disclosure in greater detail. Therefore, it should be understood that the scope of the present disclosure is not limited to the example embodiments described above or by the use of such terms unless limited by the appended claims. Also, it should be apparent to those having ordinary skill in the art that various modifications, combinations, and alternations may be made depending on design conditions and factors within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. A wireless battery management system comprising:
a cell monitoring unit (CMU) configured to monitor a status of at least one battery module comprising a plurality of battery cells; and
a battery management unit (BMU) configured to manage the CMU through wireless communication with the CMU,
wherein the CMU is configured to continuously monitor a status of the plurality of battery cells included in the battery module, and based on determining an abnormal state in at least one battery cell of the plurality of battery cells, notify the BMU of the abnormal state in the at least one battery cell, and
wherein the BMU, based on receiving notification of the abnormal state in the at least one battery cell from the CMU, is configured to transition from a sleep mode to an active mode, and respond to the abnormal state in the at least one the battery cell.

2. The wireless battery management system according to claim 1, wherein the BMU is configured to transition from the active mode to the sleep mode based on an ignition being turned off.

3. The wireless battery management system according to claim 2, wherein the BMU is configured to operate in the sleep mode using standby power of an external battery after the ignition is turned off.

4. The wireless battery management system according to claim 1, wherein the CMU is configured to operate in the active mode during a preset continuous monitoring time after an ignition is turned off.

5. A wireless battery management system comprising:
a cell monitoring unit (CMU) configured to monitor a status of at least one battery module comprising a plurality of battery cells; and
a battery management unit (BMU) configured to manage the CMU,
wherein the CMU comprises:
a battery cell monitoring unit configured to continuously monitor a status of the plurality of battery cells included in the battery module and generate battery cell status information; and
a BMU wireless interface unit configured to communicate wirelessly with the BMU and transmit the battery cell status information to the BMU, and
wherein the BMU comprises:
a CMU wireless interface unit configured to communicate wirelessly with the CMU and receive the battery cell status information;
a power supply unit configured to supply standby power of an external battery to the CMU wireless interface unit; and
a control unit configured to manage the CMU based on the battery cell status information received through the CMU wireless interface unit,
wherein the battery cell monitoring unit of the CMU is configured to, based on determining an abnormal state in at least one battery cell of the plurality of battery cells, notify the BMU of the abnormal state in the at least battery cell through the BMU wireless interface unit of the CMU, and
wherein the control unit of the BMU is configured to, based on receiving notification of the abnormal state in the at least one battery cell from the CMU through the CMU wireless interface unit of the BMU, transition from a sleep mode to an active mode and respond to the abnormal state in the at least one battery cell.

6. The wireless battery management system according to claim 5, wherein the CMU wireless interface unit of the BMU is configured to, based on receiving the notification of the abnormal state in the at least one battery cell from the BMU wireless interface unit of the CMU, wake up the control unit of the BMU.

7. The wireless battery management system according to claim 6, wherein the control unit of the BMU is configured to, based on being woken up by the CMU wireless interface unit of the BMU, request the battery cell status information from the CMU through the CMU wireless interface unit of the BMU, and determine whether the abnormal state in the at least one battery cell exists based on the battery cell status information received from the CMU.

8. The wireless battery management system according to claim 5, wherein the CMU wireless interface unit of the BMU is configured to continuously operate using the standby power of the external battery supplied by the power supply unit of the BMU after an ignition is turned off.

9. The wireless battery management system according to claim 5, wherein the battery cell monitoring unit of the CMU is configured to operate in the active mode during a preset continuous monitoring time after an ignition is turned off.

10. The wireless battery management system according to claim 5, wherein the control unit of the BMU is configured to set the CMU wireless interface unit to continuously operate during a preset continuous monitoring time based on an ignition being turned off.

11. The wireless battery management system according to claim 5, wherein the control unit of the BMU is configured to transition from the active mode to the sleep mode based on an ignition being turned off.

12. The wireless battery management system according to claim 5, wherein the control unit of the BMU and the CMU wireless interface unit of the BMU are configured to store the battery cell status information in duplicate.

13. The wireless battery management system according to claim 5, wherein the CMU wireless interface unit of the BMU includes a first CMU wireless interface unit and a second CMU wireless interface unit.

14. The wireless battery management system according to claim 5, wherein the CMU wireless interface unit of the BMU is configured in duplicate as a first CMU wireless interface unit and a second CMU wireless interface unit.

15. A method for operating a wireless battery management system, the method comprising:
continuously monitoring, by a cell monitoring unit (CMU), a status of a plurality of battery cells included in a battery module;
determining, by the CMU, an abnormal state in at least one battery cell of the plurality of battery cells;
notifying, by the CMU, a battery management unit (BMU) of the abnormal state in the at least one battery cell through wireless communication;
transitioning, by the BMU and based on receiving notification of the abnormal state in the at least one battery cell from the CMU, from a sleep mode to an active mode; and
responding, by the BMU, to the abnormal state in the at least one battery cell.

16. The method according to claim 15, wherein continuously monitoring the status of the plurality of battery cells comprises operating the CMU in an active mode during a preset continuous monitoring time after an ignition is turned off.

17. The method according to claim 15, wherein responding to the abnormal state comprises:
waking up, by a CMU wireless interface unit of the BMU, a control unit of the BMU;
requesting, by the control unit of the BMU, battery cell status information from the CMU through the CMU wireless interface unit of the BMU;
determining, by the control unit of the BMU, whether the abnormal state in the at least one battery cell exists based on the battery cell status information received from the CMU; and
responding, by the control unit of the BMU, based on the abnormal state in the at least one battery cell being determined by the control unit of the BMU, to the abnormal state in the at least one battery cell.

18. The method according to claim 15, further comprising, prior to determining the abnormal state by the CMU,
transitioning, by the BMU, from the active mode to the sleep mode after an ignition is turned off.

19. The method according to claim 15, further comprising:
generating, by a battery cell monitoring unit of the CMU, battery cell status information.

20. The method according to claim 19, further comprising:
storing, by a control unit of the BMU, the battery cell status information; and
storing, by a CMU wireless interface unit of the BMU, the battery cell status information,
wherein the battery cell status information stored by the control unit of the BMU and the battery cell status information stored by the CMU wireless interface unit of the BMU are duplicated.
